(19) United States
(12) Patent Application Publication
(10) Pub. No.: US 2024/0227850 A1
(43) Pub. Date: Jul. 11, 2024

(54) Vehicle Perception Sensor Processing with Prioritization Scheme

(71) Applicant: Aptiv Technologies AG, Schaffhausen (CH)

(72) Inventor: Adam Sven Rune PETTERSSON, Gothenburg (SE)

(21) Appl. No.: 18/540,740

(22) Filed: Dec. 14, 2023

(30) Foreign Application Priority Data
Dec. 14, 2022 (GB) 2218827.0

(51) Int. Cl. B60W 60/00; G01S 13/931

(52) U.S. Cl. CPC B60W 60/001; G01S 13/931; B60W 2420/408

(57) ABSTRACT

Disclosed is a method for processing perception sensor data in an ego vehicle. The method includes receiving sensor data associated with locations of detections in a coordinate system having a y-axis and an x-axis. The method includes assigning a priority value to the detections based on their location in the coordinate system. The method includes generating output data based on the detections and the assigned priority values. The assigned priority values are assigned based on the location of the detections in the coordinate system according to a pre-selected prioritization scheme.

### CROSS-REFERENCE TO RELATED APPLICATIONS

This application claims priority to GB App. No. 2218827.0 filed Dec. 14, 2022, the entire disclosure of which is incorporated by reference.

### FIELD

The present disclosure relates to a method of processing perception sensor detections and a processing unit for implementing the same. In particular, the present disclosure concerns automotive sensor processing methods and automotive processing units for processing perception sensor data, and most particularly RADAR sensor data. The disclosure is relevant to advanced driver assistance systems and autonomous driving technologies. Moreover, the disclosure concerns automotive electronic control units and software for implementing the above methods.

### BACKGROUND

Many modern vehicles are fitted with perception sensor systems, such as RADAR and LIDAR system, to provide localization data. Typically, sensor data from multiple sensors within a system are fused to provide for more accurate localization of the vehicle on the road. This fused sensor data is then processed to provide information about objects in the surrounding area. However, RADAR and LIDAR systems will typically receive a significant number of detections. Consequently, the computational demands required to process and track all these detections becomes excessively high in practical applications, such as in electronic control units within vehicles.

Accordingly, to focus processing resource on the most useful objects, most conventional RADAR or LIDAR processing methods will prioritize object detections based on their proximity. Accordingly, detections that are closer to the vehicle will be prioritized above those further away. For example, subsequent downstream processing resource may have capacity to process up to a fixed number of object detections. For instance, embedded systems may have a fixed number of processing paths. As such, a prioritization score may be used to determine which detections are allocated to the available processing slots, thereby down selecting the input sensor data. This is thereby intended to focus processing on the most relevant objects.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Nevertheless, there remains a need to improve automotive perception sensor processing. That is, because the systems are reliant on processing noisy and uncertain sensor measurement data, the processing demands to interpret this data remains very high. As senor sensitivity increases, and more sensors are used in combination, the need to effectively prioritize the most important objects for downstream processing only increases. In view of the above, there remains a need for improved methods and systems for processing sensor detections.

According to a first aspect, there is provided a method for processing perception sensor data in an ego vehicle, comprising: receiving sensor data associated with locations of detections in a coordinate system having a y-axis and an x-axis; assigning a priority value to the detections based on their location in the coordinate system; and generating output data based on the corresponding location of the detections and the assigned priority values, wherein the priority values are assigned based on the detections location in the coordinate system according to a pre-selected prioritization scheme.

In this way, rather than merely prioritizing detections based on proximity to the origin of the coordinate system, which is typically the location of the ego vehicle in automotive applications, priority can be more heavily weighted to objects according to a pre-selected prioritization scheme. For example, the prioritization scheme may prioritize objects ahead of the vehicle, rather than to the side or behind it. In this respect, for example, for most ADAS (advanced driver assistance systems) functions, such as ACC (adaptive cruise control), objects in front of the vehicle are more useful. Accordingly, by adopting an asymmetric prioritization scheme, processing of objects for ADAS and autonomous driving systems can be optimized.

In various embodiments, the pre-selected prioritization scheme is selected based on a set of criteria. In various embodiments, the criteria a may be selected based on, for example, driving conditions, vehicle operating parameters, and driving mode. In this way, the safety of the vehicle occupants may be enhanced based on prevailing conditions.

In various embodiments, the prioritization scheme is configured to assign areas in the coordinate system with higher priority.

In various embodiments, the sensor data is RADAR data. In this way, the tracking of objects in RADAR data, which provides both location and velocity information, can be optimized.

In various embodiments, the step of generating output data comprises down selection based on the assigned priority values. In this way, downstream processing resource can be focused on the most useful detections.

In various embodiments, the step of generating output data comprises selecting detections having an assigned priority value above a threshold. In this way, downstream processing resource can be restricted to only the most useful detections needed for subsequent processing.

In various embodiments, the threshold is determined based on a number of available tracking channels for detections, and the step of generating output data comprises selecting a detection to associate with each available tracking channel based on its assigned priority value. In this way, detections may be selected in order of priority based on the number of subsequently available processing paths. This may be used, for example, with embedded systems which may only track a limited number of objects at one time.

In various embodiments, the method further comprises the step of forwarding the generated data for downstream processing.

In various embodiments, the prioritization scheme is configured to assign a higher priority to detections coming from a selected location relative to the ego vehicle. For example, in an embodiment, the rate of variation between assigned priority the x- and y-axis may be configured such that a higher priority is assigned to detections in front of the origin in the coordinate system. In this way, objects ahead of the vehicle, and more centrally located, may for example be prioritized above those to the side.

In various embodiments, the perception sensor data is automotive perception sensor data and an origin of the coordinate system represents an ego vehicle.

According to a second aspect, there is provided a perception sensor processing unit, comprising: an input for receiving sensor data associated with locations of detections in a coordinate system having a y-axis and an x-axis; a prioritization block for assigning a priority value to detections based on their location in the coordinate system; and an output for generating output data based on the detections and the assigned priority values, wherein the priority values are assigned based on the corresponding location of the detections in the coordinate system according to a pre-selected prioritization scheme. In this way a processor unit may be provided for implementing the above method. It will be understood that the processing unit may be provided as a multidomain controller or other automotive electronic control unit.

In various embodiments, the sensor data is RADAR data.

In various embodiments, the perception sensor processing unit is an automotive electronic control unit and the origin of the coordinate system represents an ego vehicle.

In various embodiments, the step of generating output data comprises down selection based on the assigned priority values.

In various embodiments, the step of generating output data comprises down selection based on the assigned priority values.

In various embodiments, the pre-selected prioritization scheme is selected based on a set of criteria.

In various embodiments, the prioritization scheme is configured to assign areas in the coordinate system with higher priority.

According to a third aspect, there is provided a non-transient computer readable medium comprising instructions which, when executed by a computer, implement a method according to any one of the above statements.

According to a fourth aspect, there is provided a computer software product comprising instructions which, when executed by a computer, implement a method according to any one of the above statements.

### BRIEF DESCRIPTION OF THE DRAWINGS

Illustrative embodiments will be described with reference to the drawings.

FIG. 1 shows a visualization of a conventional prioritization method for RADAR sensor data.

FIG. 2 shows a schematic representation of a RADAR sensor processing unit according to an illustrative embodiment of the invention.

FIG. 3 shows a visualization of the asymmetric prioritization method for RADAR sensor data used by the processing unit shown in FIG. 2.

In the drawings, reference numbers may be reused to identify similar and/or identical elements.

### DETAILED DESCRIPTION

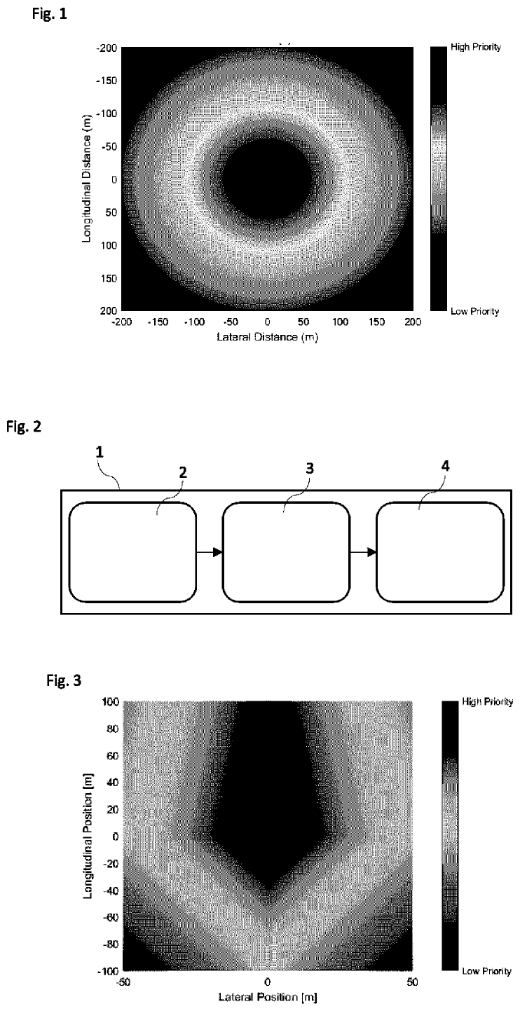

FIG. 1 shows a visualization of a conventional prioritization method based on proximity. The ego vehicle is at the center or origin at coordinates 0,0, and objects detected closer to the center are given the highest priority. Objects further away are assigned a lower priority. Accordingly, the priority is set based on the distance of the object from the center according to:

Priority Score=−(long_pos²⁺lat_pos²)

The present inventor has identified that an issue with the above conventional methodology is that objects behind and to the side of the ego vehicle are prioritized equally high as the objects in front of the vehicle. However, in practice, objects in front of the vehicle, even if further away, are more useful for downstream processing functions. For example, objects in the vehicles' path, ahead in the direction of travel, are important for accurately implementing advanced driver assistance systems or autonomous driving control.

In view of the above, in the embodiment shown in FIG. 1, an asymmetric prioritization method is adopted, which gives a higher priority or weighting to objects in front of the vehicle, rather than to the sides or behind.

In this connection, FIG. 2 shows a schematic representation of a RADAR sensor processing unit 1 according to the illustrative embodiment of the invention. In this embodiment, the processing unit 1 comprises a RADAR input 2, a prioritization block 3, and a downstream processing block 4. Data from the RADAR sensor system is fed into the RADAR input 2, from where it is first processed to prioritization block 3. The processed data output from the prioritization block is then fed to a downstream processing block 4, for example which may form part of the vehicles ADAS or autonomous driving systems, for instance for implementing adaptive cruise control.

In this connection, the prioritization block 3 applies the asymmetric prioritization method according to the visualization shown in FIG. 3.

In other embodiments more complex prioritization schemes may be used. In such embodiments, the assignment of a priority value may be more complex and hence is not as quick computationally. However, it may be used to provide, for example, a wider region of high prioritization ahead of the vehicle, facilitating better detection of wider road junctions, for example.

Accordingly, with the above methods, detections in front of the ego vehicle are prioritized for subsequent processing. As such, objects ahead of the vehicle are prioritized such that more of these objects are identified and tracked in downstream processing. Accordingly, better performance in relation to these objects may be achieved, thereby enabling higher availability of functions that rely on objects in front of the ego vehicle.

Accordingly, with the above processing unit and prioritization method, perception sensor data may be processed more effectively than existing solutions. For example, additional tracking and perception steps may be focused on the most relevant objections, thereby minimizing computational complexity, and hence increasing the ability to provide real time applications.

It will be understood that the embodiments illustrated above show applications only for the purposes of illustration. In practice, embodiments may be applied to many different configurations, the detailed embodiments being straightforward for those skilled in the art to implement.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A method for processing perception sensor data in an ego vehicle, the method comprising:
receiving sensor data associated with locations of detections in a coordinate system having a y-axis and an x-axis;
assigning a priority value to the detections based on their location in the coordinate system; and
generating output data based on the detections and the assigned priority values,
wherein the assigned priority values are assigned based on the location of the detections in the coordinate system according to a pre-selected prioritization scheme.

2. The method of claim 1 wherein the pre-selected prioritization scheme is selected based on a set of criteria.

3. The method of claim 1 wherein the prioritization scheme is configured to assign areas in the coordinate system with higher priority.

4. The method of claim 1 wherein generating output data includes down selection based on the assigned priority values.

5. The method of claim 1 wherein generating output data includes selecting detections having an assigned priority value above a threshold.

6. The method of claim 5 wherein:
the threshold is determined based on a number of available tracking channels for detections, and
generating output data includes selecting a detection to associate with each available tracking channel based on its assigned priority value.

7. The method of claim 1 further comprising forwarding the generated data for downstream processing.

8. The method of claim 1 wherein the prioritization scheme is configured to assign a higher priority to detections coming from a selected location relative to the ego vehicle.

9. The method of claim 1 wherein the sensor data is RADAR data.

10. A perception sensor processing unit comprising:
an input configured to receive sensor data associated with locations of detections in a coordinate system having a y-axis and an x-axis;
a prioritization block configured to assign a priority value to the detections based on their location in the coordinate system; and
an output configured to generate output data based on the detections and the assigned priority values,
wherein the assigned priority values are assigned based on the location of the detections in the coordinate system according to a pre-selected prioritization scheme.

11. The perception sensor processing unit of claim 10 wherein:
the perception sensor processing unit is an automotive electronic control unit; and
an origin of the coordinate system represents an ego vehicle.

12. The perception sensor processing unit of claim 11 wherein generating output data includes down selection based on the assigned priority values.

13. The perception sensor processing unit of claim 10 wherein generating output data includes down selection based on the assigned priority values.

14. The perception sensor processing unit of claim 10 wherein the pre-selected prioritization scheme is selected based on a set of criteria.

15. The perception sensor processing unit of claim 10 wherein the prioritization scheme is configured to assign areas in the coordinate system with higher priority.

16. A non-transitory computer-readable medium comprising instructions including:
receiving sensor data associated with locations of detections in a coordinate system having a y-axis and an x-axis;
assigning a priority value to the detections based on their location in the coordinate system; and
generating output data based on the detections and the assigned priority values,
wherein the priority values are assigned based on the location of the detections in the coordinate system according to a pre-selected prioritization scheme.
